(19) United States
(12) Patent Application Publication
(10) Pub. No.: US 2011/0088867 A1
(43) Pub. Date: Apr. 21, 2011

(54) System for and Method of Rotating Wheels in Rotary Air-to-Air Energy and Moisture Transfer Systems

(75) Inventors: Donald F. Steele, Cohasset, MA (US); Edward C. Lovelace, Arlington, MA (US); Roger B. Dickinson, Torrington, CT (US)

(73) Assignee: Airxchange, Inc., Rockland, MA (US)

(21) Appl. No.: 12/839,082

(22) Filed: Jul. 19, 2010

Related U.S. Application Data
(63) Continuation-in-part of application No. 11/655,421, filed on Jan. 19, 2007, now abandoned.
(60) Provisional application No. 60/760,287, filed on Jan. 19, 2006.

(51) Int. Cl. F28D 19/04; H02K 19/10

(52) U.S. Cl. 165/9; 310/67 R

(57) ABSTRACT

The disclosed system provides heat and/or moisture transfer between two counter-flowing air streams. The system comprises: a frame; a transfer wheel having a periphery spaced from the frame so as to form a gap therebetween, and including a transfer matrix mounted and rotationally secured relative to the frame so that the wheel can simultaneously rotate through the two separate, counter-flowing air streams; a sealing arrangement configured so as to seal the transfer wheel to the frame so that as the wheel rotates through the two separate counter-flowing air streams, the two air streams flow through the transfer matrix while remaining sealed from one another; and an electromagnetic actuator including rotational components secured relative to the wheel configured to generate flux across the gap and stationary components secured relative to the frame configured to impart a tractive force to the rotational components in response to polyphase power supplied to the stationary components.

### RELATED APPLICATIONS

The present application is a continuation-in-part of and claims priority from U.S. patent application Ser. No. 11/655,421 filed Jan. 19, 2007, which in turn is related to and claims priority from U.S. Provisional Patent Application 60/760,287 filed Jan. 19, 2006.

### FIELD

The present disclosure relates generally to energy and moisture transfer wheels and, more particularly, to improvements in systems for methods of rotating such wheels in rotary air-to-air energy recovery and in active and passive humidification and used dehumidification systems.

### BACKGROUND

Energy and moisture transfer wheels are well known for effecting the transfer of heat and/or moisture between two counter-flowing air streams. Such transfer wheels are typically used to control the temperature and/or humidity of air within buildings, wherein the counter-flowing air streams can be incoming and outgoing air.

A drive motor is usually mounted adjacent to and coupled with a pulley and a drive belt to the transfer wheel so that the wheel can be rotationally driven about its axis during operation. Further, the drive motor is usually selected from a large group that are typically employed for such applications, the particular selection depending on various factors such as the size and weight of the wheel, and the available building power supplies that can range from 120 to 575 VAC with frequencies typically of 50 Hz or 60 Hz, with single phase or three phase configurations. In some applications the motor may be energized by an adjustable speed drive (ASD) power converter so that the rotation rate of the wheel can be controlled.

Accordingly, it is desirable to provide a more integrated solution for rotating the wheel that can operate within the full range of expected power system voltages, operating frequencies and phase configurations, as well as provide rotation at any one of a plurality of selectable predetermined speeds or at an adjustable variable speed.

### SUMMARY

In accordance with one aspect, a system provides heat and/or moisture transfer between two counter-flowing air streams. The system comprises: a frame; a transfer wheel having a periphery spaced from the frame so as to form a gap therebetween, and including a transfer matrix mounted and rotationally secured relative to the frame so that the wheel can simultaneously rotate through the two separate, counter-flowing air streams; a sealing arrangement configured so as to seal the transfer wheel to the frame so that as the wheel rotates through the two separate counter-flowing air streams, the two air streams flow through the transfer matrix while remaining sealed from one another; and an electromagnetic actuator including components secured relative to the wheel configured to generate flux across the gap and electromagnetic stationary components secured relative to the frame configured to impart a tractive force to the rotational components in response to polyphase power supplied to the stationary components.

In accordance with another aspect a system provides heat and/or moisture transfer between two counter-flowing air streams. The system comprises: a frame; a transfer wheel including a transfer matrix mounted to rotate relative to the frame so that the wheel can simultaneously rotate through the two separate, counter-flowing air streams and heat and/or moisture can be transferred between the two counter-flowing air streams as the wheel rotates; a sealing arrangement configured so as to seal the transfer wheel to the frame so that as the wheel rotates through the two separate counter-flowing air streams, the two air streams flow through the transfer matrix while remaining sealed from one another; and at least one electromagneticactuator including (a) a first component secured relative to the wheel and including (i) a ferromagnetic band fixedly mounted relative to the periphery of the wheel, and a (ii) plurality of permanent magnets fixedly mounted to the ferromagnetic band, and (b) a second component secured relative to the frame and including at least one polyphase excitable electromagnetic core-coil assembly; wherein a circumferentially translating magnetic field interacting with that of the permanent magnets and ferromagnetic band on the wheel periphery is created in response to polyphase power supplied to the core-coil assembly so as to impart a tractive force to the wheel periphery sufficient to overcome retarding friction and wheel inertia in order that the wheel may be accelerated to and be maintained at a desired predetermined rotational rate.

### GENERAL DESCRIPTION OF THE DRAWINGS

Reference is made to the attached drawings, wherein elements having the same reference character designations represent like elements throughout, and wherein:

FIG. 1 shows a side view, in cross-section of a counter-flow heat exchanger disposed within a counter-flow heat and/or moisture transfer system disposed within a counter-flow air system;

FIG. 2 is a frontal view of the frame and wheel of the counter-flow heat and/or moisture transfer system;

FIG. 3 is a perspective view of an assembled electromagnetic actuator arrangement for use in the counter-flow heat and/or moisture transfer system;

FIG. 4 is an exploded view of the electromagnetic actuator arrangement of FIG. 3 configured for 2 phase excitation; and

FIG. 5 is an exploded view of a portion of the electromagnetic actuator arrangement of FIG. 3 configured for 2 phase excitation.

### DETAILED DESCRIPTION OF THE DRAWINGS

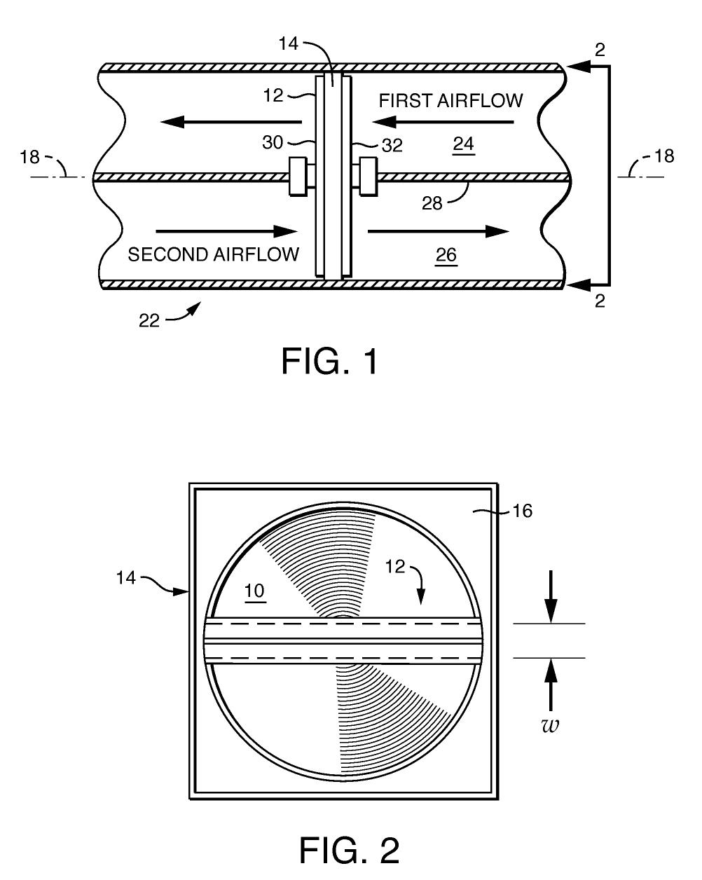

Referring to FIGS. 1 and 2, the present disclosure provides a heat and/or moisture transfer matrix 10 for use as part of a heat and/or moisture transfer wheel 12 in a counter-flow heat and/or moisture transfer system 14, also referred to as a heat and/or moisture “exchange” system. The transfer wheel 12 is rotationally mounted about rotation axis 18 within a frame 16. The transfer matrix 10 is constructed with narrow air passageways so as to transfer heat and moisture between two counter-flowing air streams. The transfer matrix 10 can further include one or more desiccant materials for enhancing the moisture transfer from the more humid air to the drier air. Frame 16 includes a single seal plate, or multiple plate pieces substantially surrounding the transfer wheel 12 so that substantially all of the air of the counter-flowing air streams will pass through the transfer matrix.

As shown in FIGS. 1 and 2, the heat and/or moisture transfer system 14 is configured as a part of an air flow system 22. System 22 can include a flow duct 24 and a counter-flow duct 26 separated by a wall(s) 28. A first airflow is received by the flow duct 24, while a second airflow is received by the counter-flow duct 26. As their names imply, the flow and counter-flow ducts 24, 26 direct airflows in opposite directions through the wheel 12. One airflow is warmer and/or more humid than the other, so that as the wheel turns some of the heat and/or moisture is transferred by the wheel from the warmer and/or more humid air to the cooler drier air. Alternatively, the air flow system can include a cabinet designed to have two counter-flowing air streams pass through the cabinet, and constructed so that the transfer wheel 12 and frame 16 can be mounted therein.

The transfer wheel 12 is mounted within the air flow system 22 for simultaneous rotation through the flow duct 24 and the counter-flow duct 26, with an outer circumference of the wheel 12 forming a nearly air-tight seal between the wheel 12 and the frame 16 so as to insure flow through the matrix, and between the flow and counter-flow ducts 24 and 26 so as to prevent leakage between the ducts 24 and 26. A seal around the perimeter of the wheel insures that air flows through the matrix as the wheel rotates.

The narrow air passageways of transfer matrix 10 of transfer wheel 12 extend between the faces 30 and 32 of the wheel 12. Accordingly, the first airflow passes through the wheel 12 from the second face 32 to the first face 30, while the second airflow passes through the wheel 12 from the first face 30 to the second face 32. As the wheel rotates heat and/or moisture can be transferred between the two airflows.

In accordance with the teachings of the present disclosure, a separate drive motor, belt and pulley are eliminated, and the transfer wheel 12 and frame 16 are modified and configured to include electromagnetic actuator components so as to function as an integrated assembly. In one embodiment an electromagnetic actuator (herein referred to simply as an “actuator”) includes a plurality of permanent magnets fixedly mounted to a ferromagnetic band, which in turn is attached to the periphery of the transfer wheel. The actuator also includes one or more electromagnetic core-coil assemblies fixedly mounted to the frame wherein polyphase power supplied to the core-coil assemblies develops a circumferentially translating magnetic field interacting with that of the permanent magnets and ferromagnetic band, so as to impart a tractive force to the periphery of the wheel sufficient to overcome retarding friction and wheel inertia so that the wheel may be accelerated to and be maintained at one or more predetermined rotational rates or an adjustable rotational rate through the two counter-flowing air streams. The polyphase power supplied can be provided in the form of two-phase, three-phase, four-phase or higher phase current. The current can be in any form such as a sinusoidal or rectangular waveform.

The actuator components employed will depend on the actuator design. The actuator components secured relative to the wheel periphery can be active or passive devices. Active devices include components secured relative to the periphery and energized through brushes and slip rings, brushes and a multi-segmented mechanical commutator, a brushless rotary transformer or similar means of conveying electrical power to the rotating assembly. Alternatively passive devices such as permanent magnets can be utilized, which require no excitation current. The electrically energized actuator components comprised of coil-core units fixed to the wheel frame preferably have an angular extent interacting only with a small portion of the components secured to the wheel. There are many types of designs for such electromagnetic actuators including those where coil currents are controlled in accordance with wheel rotation angle with or without the use of wheel position sensors and those where the wheel may be assumed to rotate in synchronism with autonomously controlled coil currents modulated in sinusoidal or step-wise fashion. Actuator designs may employ permanent magnets fixed to the rotor. The magnets will experience a tangential or “tractive” force to induce wheel rotation by interaction of their magnetic fields with fields produced by currents flowing in the fixed coils fixed relative to the frame. Other electromagnetic actuator designs may develop a rotor magnetic field as a consequence of eddy currents induced in a conductive rotor rim by the field of the fixed coils. Alternatively, the rotor may be provided with salient ferromagnetic poles which enable the development of a tractive driving force as a consequence of such poles seeking to align with stationary energized coil-core poles fixed relative to the frame. All such electromagneticactuators use electronic means to control the coil currents in the fashion required to develop tractive force at the wheel periphery. Such control for an actuator employing permanent magnets fixed relative to the rotor and wheel position sensors fixed relative to the frame may be achieved with integrated circuit chips MC33035 and MC33039 manufactured by On Semiconductor. See Brushless DC Motor Controller, Publication Order Number: MC33033/D, April, 2004, Rev. 7, published by On Semiconductor, pages 1-24. Similar control functionality is provided by chip LS7560N manufactured by LSI Computer Systems, Inc. See “LS7560N/LS7561N Brushless DC Motor Controller” published by LSI Computer Systems, Inc. Both On Semiconductor and LSI Computer Systems control solutions are supported by conventional power electronic components suitable for switching of coil currents and components which provide DC power at one or more voltages for operation of the control chips and provision of coil excitation.

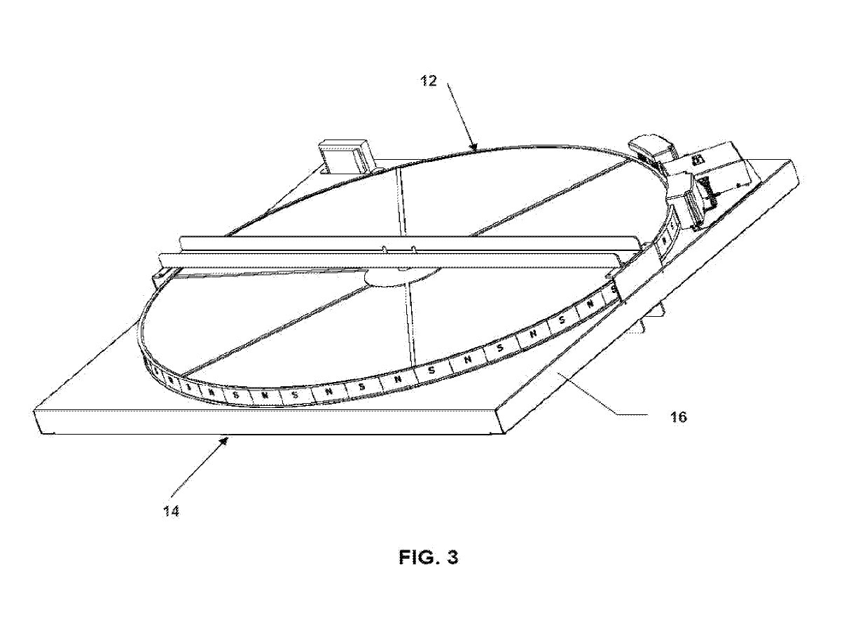

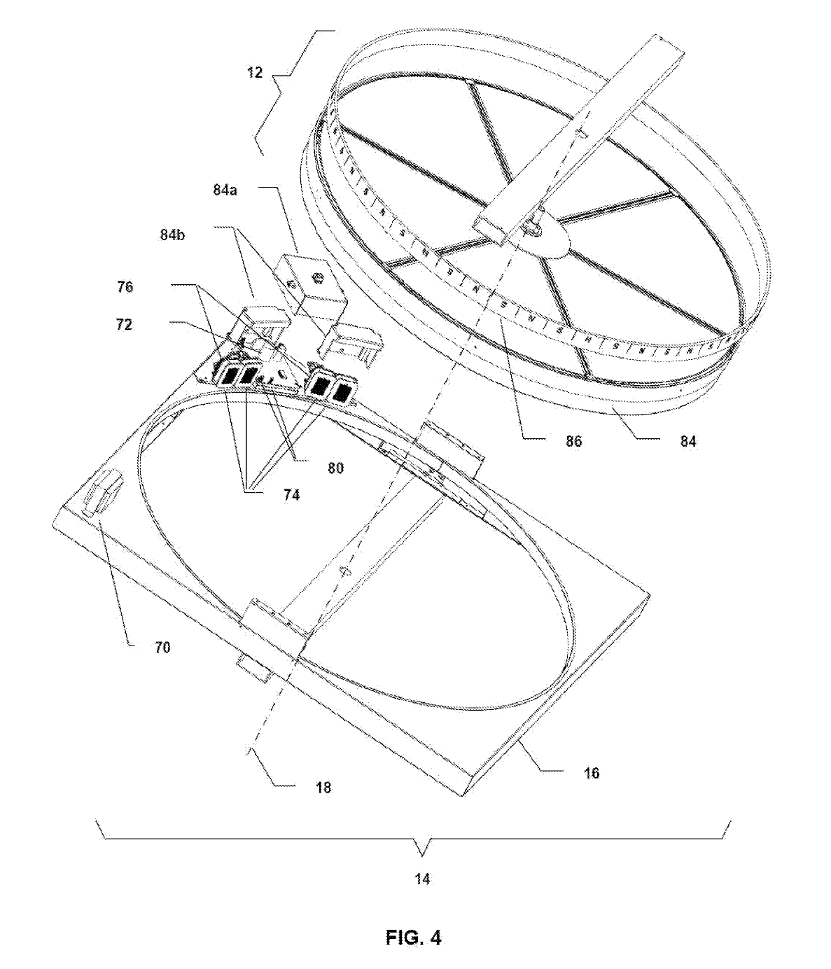

FIGS. 3 and 4 show one embodiment integrated system including the wheel 12 and frame 16 of counter-flow heat and/or moisture transfer system 14, and also includes the electromagnetic actuator. The system is modified to include an electromagneticactuator providing a tractive force at the wheel periphery to induce its rotation. Specifically, the wheel 12 is modified to include a first plurality of actuator components fixed relative to the wheel periphery so that components of the first plurality can interact with the second plurality of actuator components fixed relative to the frame to produce the tractive force. A power converter 70 (including a transformer, if necessary) is provided for converting the available power to conform to suitable power parameters for energizing a coil current commutation controller 72 attached to frame 16. The power converter transformer (in this case power converter components other than the transformer are integrated with the coil current commutation controller assembly 72) is shown secured to the frame 16, although it can be secured elsewhere. Assemblies of actuator coils 74 and ferromagnetic cores 76 are secured relative to the frame 16. At least one or two or more assemblies of coils 74 and ferromagnetic cores 76 are used and secured relative to the frame 16 so that the core pole faces of these assemblies are positioned adjacent to the magnets attached to the periphery of wheel 12. A cover 82a may be used to protect the commutation controller 72 from dust and moisture and separate cover(s) 82b may be used to similarly protect assemblies of coils 74 and ferromagnetic cores 76. Finally, a plurality of commutation control sensors 80 are secured relative to the frame 16 for sensing the position of the wheel 12 as it rotates on its axis 18. The sensors 80 may be mounted on the coil current commutation controller 72 as shown or separately mounted to the frame 16. The sensors 80 can be mounted so that they are positioned in between the assemblies of coils 74 and cores 76 as shown or angularly distant from these assemblies as desired. The sensors 80 can also be eliminated if provision is made in the coil current commutation controller 72 to determine wheel angular position by means of voltages induced in the fixed coils due to rotation of the magnets 86 attached to the wheel periphery. Alternatively, coil currents may be switched autonomously without consideration of wheel angular position if coil current commutation rate is raised slowly during start up so that wheel inertia will not inhibit its acceleration to operating speed. Where sensors 80 are provided for control of coil current commutation, at least three such sensors are provided to implement a three phase electromagnetic actuator and at least two such sensors are used when implementing a two phase electromagneticactuator. Further, for large wheels, additional assemblies of coils 74 and ferromagnetic cores 76 can be employed to provide additional tractive force at the periphery of wheel 12.

The wheel 12 shown in FIGS. 3 and 4 can also be modified to include actuator components. Toby, shouldn't this read “The wheel 12 shown in FIG. 3 is modified to include actuator components.” For example, the wheel can be provided with a continuous “magnet back iron” strip 84 of ferromagnetic material disposed continuously around the periphery of the wheel, and a flexible strip of permanent magnet material 86 for providing a plurality of permanent magnetic poles magnetized in radially alternating north and south directions and distributed around the wheel periphery. Alternatively, the rim itself can be made of ferromagnetic material so as to eliminate the need for the applied strip. The wheel can be provided with a plurality of separate permanent magnets distributed around the periphery. The ferromagnetic back iron strip 84 underlying the magnet strip or plurality of separate magnets provides a low reluctance path to enhance the magnetic flux the magnets establish across the air gap between the wheel periphery and ferromagnetic cores 76. The magnetic flux links with the coils 74 via ferromagnetic cores 76 to interact with the magnetic field produced by coil currents in a manner which produces a tractive force to rotate the wheel. As best seen in FIG. 3, the strip 86 (or if the alternative arrangement of permanent magnets is used) provides a magnetic pattern of alternating north and south poles as one progresses around the rim of the wheel 12.

In operation, external power is delivered to power converter 70, which in turn provides the appropriate power within appropriate parameters to the coil current commutation controller 72 (hereinafter the “controller”). The controller 72 provides the necessary current driving voltages to coils 74 so as to create a time-varying magnetic flux linking with the wheel periphery, and in particular with the magnetic strip 86 and magnet back iron strip 84. This creates a tractive force causing the wheel to rotate. The controller 72 can be provided with an input so that the rotational speed of the wheel can be adjusted or set to one or more pre-selected values, accommodating substantially all anticipated modes of operation of the heat and/or moisture transfer system.

The electromagneticactuator employed to drive wheel 12 can be controlled using, for example, methods similar to that used for controlling so-called brushless DC motors of the type using sensors, as well as those without sensors, as described at http://en.wikipedia.org/wiki/Brushless_DC_electric_motor (Jan. 12, 2007). As indicated the coil current commutation controller is used to effect development of a tractive force to establish rotation of wheel 12. Optimum performance is attained when commutation timing is such that the fundamental component of the coil current is nominally in phase with the coil back emf induced by the moving magnet array for which condition maximum tractive force per ampere of coil current is achieved or alternatively, current and coil I²R loss is minimized to attain a required tractive force. Maximizing tractive force per ampere also minimizes coil current commutation controller drive component ratings and losses and potential for demagnetization of the permanent magnets by the coil-core field (aka “armature reaction”). For a design using sensors, the coil current commutation controller uses commutation sensors to determine the orientation of magnet poles deployed about the periphery of wheel 12 with respect to the coil-core assemblies fixedly attached relative to the frame 16 in order to achieve the above-described optimal alignment of coil current and coil back emf. Hall effect sensors are most commonly used for this purpose, but one can also use other sensing devices such as other magnetic sensors, or an optical rotary encoder to directly measure the angular orientation of the magnet poles deployed about the periphery of the wheel 12. Other brushless DC motor control methods take advantage of the circumstance that for a portion of a commutation cycle one of the coil-core assemblies is unexcited and by monitoring the voltage induced in this coil by adjacent moving magnets the orientation of the magnets may be inferred to determine the timing of the next coil current commutation event. This approach avoids the need for commutation sensors. However, this “sensorless” control method is typically not very effective for operation at very low speed applications as the induced voltage, proportional to magnet velocity, becomes too small for reliable control.

The electromagneticactuator used in the modified heat and/or moisture transfer system 14 might alternatively be controlled in the fashion of a stepper motor without need for commutation control sensors where coil currents are autonomously commutated without the use of wheel position sensors. However, successful operation in this mode requires low wheel inertia so that it is able to accelerate in a timely fashion to follow the autonomous coil current commutations. In this regard, start up may be impossible or unreliable but may be facilitated by employing a programmed ramp up of the commutation rate. It is likely that stepper motor-like control will only be successful for very small, low inertia wheels. A more successful sensorless control for wheels of any size and inertia is expected to be one where the magnet orientation with respect to coil-core assemblies is determined by monitoring the voltage induced in an unexcited coil as previously explained, where commutation events are assured to be synchronous with optimum magnet orientation.

In summary, actuator coil currents may be controlled autonomously as in the case of the stepper mode or controlled by wheel position sensors or induced voltages in unexcited coils.

Where coil currents are controlled autonomously, as in the case of the stepper mode, wheel speed can be adjusted or set to one or more predetermined values by adjustment of the autonomous coil current switching frequency. Where coil currents are controlled according to wheel position, as observed by sensors or induced voltages in unexcited coils, wheel speed is controlled, in closed loop fashion, by modulating coil current amplitude to control the developed tractive force such that observed wheel speed is brought into alignment with a target or set point speed with acceptable error. Coil current control is preferably implemented by pulse width modulation (PWM) of coil excitation voltages. The closed loop controller can employ well-known proportional (P), proportional-integral (PI) or proportional-integral-derivative (PID) control policies to adjust the PWM duty cycle in accordance with the difference between observed and set point speeds. Wheel position commutation sensor or induced coil voltage signals can be employed to observe the wheel speed. Speed set point can be set to one or more predetermined values by binary command signals provided by a higher level system controller. Alternatively the higher level system controller can provide a continuously adjustable speed set point command in the form of an analog signal such as a 4 to 20 mA loop current or 0 to 10V voltage, or as a digital signal in serial data, PWM or variable frequency format. By this means continuous adjustable speed control by a higher level system can be implemented on an open-loop basis where wheel speed determined by the adjustable speed command is sufficiently accurate. Alternatively the higher level control system can monitor a tachometer pulse signal generated by the wheel commutation controller in order to implement outer loop control of wheel speed to achieve improved adjustable speed accuracy.

For any of these coil current control policies the poles of the actuator core-coil assemblies will typically be positioned about the periphery of the wheel so that a first group of assemblies will be aligned with adjacent north and south magnet segments in an orientation yielding a high level of tractive force when their coils are excited by currents having preferred directions and a second group of un-excited core-coil assemblies will not be so favorably aligned. After an increment of wheel rotation the first group of core-coil units will no longer be favorably aligned and will be de-energized while the second group will be energized with currents having preferred directions as they attain alignment with adjacent north and south magnet segments favorable to tractive force production. Rotation of the wheel is sustained by cyclically energizing selected actuator core-coil assemblies with currents in alternating directions to maintain a continuous driving tractive force.

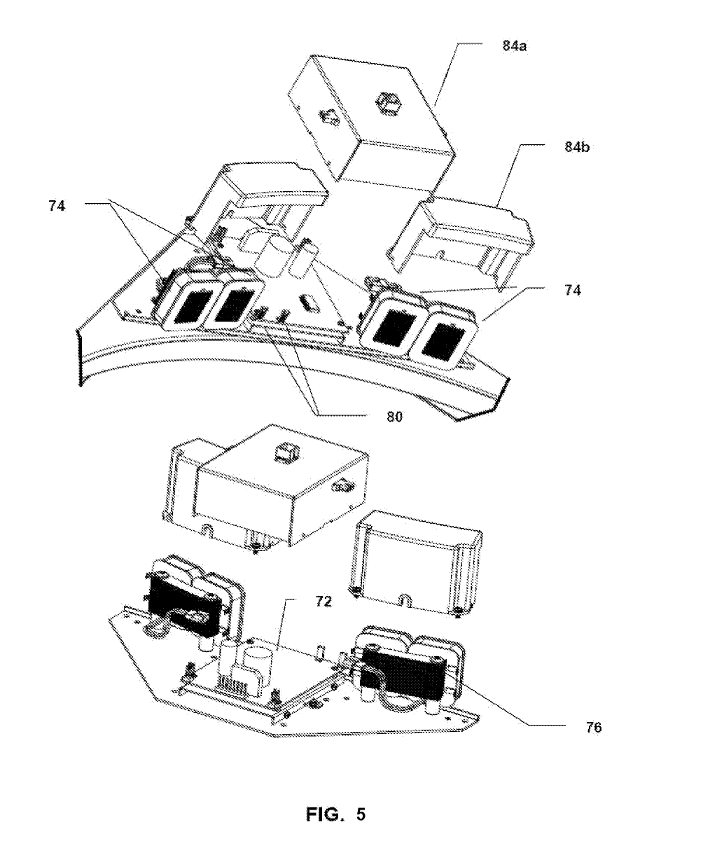

If core-coil assemblies are configured to be magnetically independent, so that there is no need for cores to support mutual flux linkages, then these assemblies may be deployed at any convenient circumferential location about the wheel provided that those of a first group of assemblies will be aligned with adjacent north and south magnet segments in an orientation yielding a high level of tractive force when their coils are excited by currents having preferred directions and a second group of un-excited core-coil assemblies will not be so favorably aligned. The utility of separating core-coil assemblies is illustrated in FIG. 4 and FIG. 5 where these assemblies are separated to permit a compact configuration with the commutation controller with on-board commutation control sensors located between them.

Thus, a new and improved heat and/or moisture transfer system and method integrated to include electromagnetic actuator components provided in accordance with the present disclosure have been described. The exemplary embodiments described in this specification have been presented by way of illustration rather than limitation, and various modifications, combinations and substitutions may be effected by those skilled in the art without departure either in spirit or scope from this disclosure in its broader aspects and as set forth in the appended claims. Thus, providing electromagnetic actuator components to the wheel 12 and frame 16 of a counter-flow heat and/or moisture transfer system eliminates the need for a drive motor, belt and pulley. Further, fewer design choices are necessary to cover all of the potential applications, including the range of possible wheel sizes and power sources. In addition, the speed of the wheel 12 can be controlled as required without addition of a separate adjustable speed drive.

The new and improved heat and/or moisture transfer system and method of the present disclosure as disclosed herein, and all elements thereof, are contained within the scope of at least one of the following claims. No elements of the presently disclosed system and method are meant to be disclaimed, nor are they intended to necessarily restrict the interpretation of the claims. In these claims, reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system for providing heat and/or moisture transfer between two counter-flowing air streams, comprising:
a frame;
a transfer wheel having a periphery spaced from the frame so as to form a gap therebetween, and including a transfer matrix mounted and rotationally secured relative to the frame so that the wheel can simultaneously rotate through the two separate, counter-flowing air streams;
a sealing arrangement configured so as to seal the transfer wheel to the frame so that as the wheel rotates through the two separate counter-flowing air streams, the two air streams flow through the transfer matrix while remaining sealed from one another; and
an electromagnetic actuator including components secured relative to the wheel configured to generate flux across the gap and stationary components secured relative to the frame configured to impart a tractive force to the rotational components in response to polyphase power supplied to the stationary components.

2. A system according to claim 1, wherein the rotational components includes a ferromagnetic band, and a plurality of permanent magnets fixedly mounted to the ferromagnetic band, the magnets and band forming the rim of the periphery of the wheel, and the stationary components include at least one core-coil assembly fixedly mounted at at least one location and configured so as to impart a tractive force to the permanent magnets and ferromagnetic band in response to polyphase power supplied to the core-coil assembly.

3. A system according to claim 2, wherein polyphase power supplied to the core-coil assembly develops a circumferentially translating magnetic field interacting with that of the permanent magnets on the wheel rim so as to impart a tractive force to the wheel periphery sufficient to overcome retarding friction and wheel inertia in order that the wheel may be accelerated to and be maintained at at least one predetermined rotational rate.

4. A system according to claim 3, wherein the core-coil assembly is configured to be excited by two, three, four or higher order phase polyphase currents.

5. A system according to claim 4, wherein the core-coil assembly is configured to be excited by two, three, four or higher order phase polyphase currents provided as sinusoidal or rectangular waveforms.

6. A system according to claim 4, wherein the frequency and phase of the polyphase excitation is determined by at least one sensor fixedly mounted relative to the frame.

7. A system according to claim 6, wherein the sensor is a magnetic sensor.

8. A system according to claim 7, wherein the magnetic sensor is a Hall effect sensor.

9. A system according to claim 6, wherein the sensor is an optical sensor.

10. A system according to claim 4, wherein the frequency and phase of the polyphase current is determined sensing the back EMF developed in certain unexcited coils

11. A system according to claim 4, further including a single phase power transformer providing AC power at 24 VAC or other standard voltage, which AC power, after rectification and filtering by a power converter and further processing by a commutation controller enables energizing the core-coil assemblies with polyphase currents.

12. A system according to claim 1, wherein the tractive force imparted to the wheel can be controlled so that the desired predetermined rotational rate can be selected from one of a plurality of rotational rates.

13. A system according to claim 1, wherein the tractive force imparted to wheel can be varied so that the rotational rate can be varied.

14. A system for providing heat and/or moisture transfer between two counter-flowing air streams, comprising:
a frame;
a transfer wheel including a transfer matrix mounted to rotate relative to the frame so that the wheel can simultaneously rotate through the two separate, counter-flowing air streams and heat and/or moisture can be transferred between the two counter-flowing air streams as the wheel rotates;
a sealing arrangement configured so as to seal the transfer wheel to the frame so that as the wheel rotates through the two separate counter-flowing air streams, the two air streams flow through the transfer matrix while remaining sealed from one another; and
at least one electromagnetic actuator including (a) a first component secured relative to the wheel and including (i) a ferromagnetic band fixed to the periphery of the wheel and (ii) a plurality of permanent magnets fixedly mounted relative to the ferromagnetic band, and (b) a second component secured relative to the frame and including at least one polyphase excitable core-coil assembly;
wherein a circumferentially translating magnetic field interacting with that of the permanent magnets and ferromagnetic band on the wheel periphery is created in response to polyphase power supplied to the core-coil assembly so as to impart a tractive force to the wheel periphery sufficient to overcome retarding friction and wheel inertia in order that the wheel may be accelerated to and be maintained at a desired predetermined rotational rate.

15. A system according to claim 14, wherein the tractive force imparted to the wheel can be controlled so that the desired predetermined rotational rate can be selected from one of a plurality of rotational rates.

16. A system according to claim 14, wherein the tractive force imparted to wheel can be varied so that the rotational rate can be varied.
